(19) United States
(12) Patent Application Publication
(10) Pub. No.: US 2004/0056472 A1
(43) Pub. Date: Mar. 25, 2004

(54) Fuel fill assembly and method of forming same

(75) Inventor: Dean Jeffrey Schneider, Washington, MI (US)

Correspondence Address: DOBRUSIN & THENNISCH PC, 401 S OLD WOODWARD AVE, SUITE 311, BIRMINGHAM, MI, 48009, US

(73) Assignee: L&L Products, Inc., Romeo, MI

(21) Appl. No.: 10/659,458

(22) Filed: Sep. 10, 2003

Related U.S. Application Data
(60) Provisional application No. 60/413,493, filed on Sep. 25, 2002.

(51) Int. Cl. B60P 3/22

(52) U.S. Cl. 280/834

(57) ABSTRACT

There is disclosed a fuel fill assembly and a method of forming the same. The assembly typically includes a first component (e.g., an outer body panel) and a second component (e.g., a wheelhouse) of an article of manufacture such as an automotive vehicle. The assembly also typically include an annular member at least partially between the first and second components and a pair of seal for sealing between the annular member and the first and second components.

### CLAIM OF BENEFIT OF FILING DATE

The present application claims the benefit of the filing date of U.S. Provisional Application Serial No. 60/413,493, filed Sep. 25, 2002, hereby incorporated by reference.

### FIELD OF THE INVENTION

The present invention relates generally to a fuel fill assembly that is preferably for a transportation vehicle such as an automotive vehicle, a boat, a motorcycle or the like.

### BACKGROUND OF THE INVENTION

For many years, the transportation industry has been concerned with designing fuel fill assemblies that have one or more of several desirable characteristics. Such characteristics include, without limitation, low weight, effective sealing, strength, ease of assembly, low cost, minimal component complexity or the like. The present invention provides an improved fuel fill assembly exhibiting one or more of these desirable characteristics.

### BRIEF DESCRIPTION OF THE DRAWINGS

The features and inventive aspects of the present invention will become more apparent upon reading the following detailed description, claims, and drawings, of which the following is a brief description:

FIG. 1 is a side sectional view of an exemplary fuel fill assembly formed in accordance with an aspect of the present invention.

### DETAILED DESCRIPTION OF THE PREFERRED EMBODIMENT

The present invention is predicated upon providing an improved fuel fill assembly for an article of manufacture. Preferably, the article of manufacture is a transportation vehicle such as an automotive vehicle, a boat or a motorcycle, although it is contemplated that the fuel fill assembly may be employed in other articles of manufacture such as lawn mowers, snowmobiles, fuel tanks or other articles.

The fuel fill assembly will typically include one or more of the following components:

a) a first component of an article of manufacture;

b) a second component of the article of manufacture;

c) a member disposed at least partially between the first component and the second component wherein the member is preferably a plastic tubular structure;

d) one or more seals disposed between the member and one or both of the first component and the second component.

Advantageously, the material employed for the seals is fuel-resistant (i.e., the material is resistant to degradation that might otherwise be caused by exposure to fuels such as gasoline or fuels vapors). Additionally, the material employed for the seals is preferably capable of adhering to multiple types of materials and particularly plastics and metals which are the preferred materials for the components of the article of manufacture and the member disposed between those components.

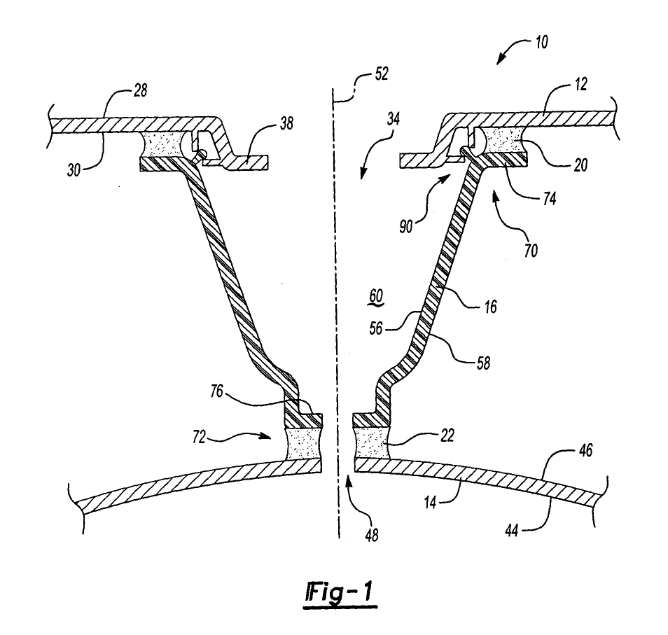

Referring to FIG. 1, there is illustrated an exemplary fuel fill assembly 10 formed in accordance with the present invention. The fuel fill assembly 10 is comprised of a first component 12 of an article of manufacture, a second component 14 of an article of manufacture, and a member 16 disposed at least partially between the first and second components 12, 14. The fuel fill assembly 10 also includes a first seal 20 positioned between the member 16 and the first component 12 and a second seal 22 positioned between the member 16 and the second component 14.

The first component 12 is illustrated as a body side outer panel of an automotive vehicle. In alternative embodiments, however, the first component 12 may be a component of a variety of articles of manufacture or may be a different component of an automotive vehicle. As an alternative, for example, the first component may be a body side inner panel of an automotive vehicle. Preferably, the first component 12 includes a first surface 28 opposite a second surface 30. It is also preferable for the first component 12 to define an opening 34 (e.g., a through-hole) for receipt of fuel therethrough. In the embodiment depicted, the first component 12 includes a flange 38 that at least partially defines the opening 34.

The second component 14 is illustrated as a wheelhouse of the automotive vehicle. Alternatively, it is contemplated that the second component may be a component of a variety of articles of manufacture or may be a different component of an automotive vehicle. In exemplary alternatives, the second component may be an inner body panel of an automotive vehicle, a frame member of a vehicle or the like. Preferably, the second component 14 also includes a first surface 44 opposite a second surface 46. The second component 14 also preferably defines an opening 48 (e.g., a through-hole) for receipt of fuel (e.g., gasoline) therethrough.

Both the first component 12 and the second component 14 may be formed of a variety of material such as polymers, plastics, metals or the like. In a preferred embodiment, both the first component 12 and the second component 14 are formed of metals such as steel, magnesium, aluminum, iron, combinations thereof or the like.

The member 16 is illustrated as a tubular or annular member, which is cup-shaped. The annular shape of the member 16 may be substantially symmetric about a central axis 52 as shown. However, the member 16, particularly when formed of polymers or plastic, may be formed in any shape desired and may advantageously be shaped to adapt to the positioning of the components 12, 14 relative to each other. The member 16 typically includes a first surface 56 opposite a second surface 58. As shown, the member 16 is annular about and at least partially defines (e.g., with its first surface) an open space 60 that extends between, interconnects (e.g., provides fluid communication between) and may include the opening 34 in the first component 12 to the opening 48 in the second component 14 for forming a fuel passageway. The member 16 typically includes a first end 70 opposite a second end 72. In the particular embodiment illustrated, the first end 70 and the second end 72 respectively include a first flange 74 and a second flange 76.

The member 16 may be formed of a variety of materials such as plastics, polymers or metals. Preferably, the member is formed of a polymeric plastic or thermoplastic. Examples of a few suitable polymers include, but are not limited to, polyethylene, polypropylene, polyamide (e.g., nylon), polystyrene, combinations thereof or the like. Preferably, the member 16 is formed by molding (e.g., blow molding, injection molding or the like), but may be formed by other techniques as well.

The seals 20, 22 may be formed in a variety of shapes and configurations and may be continuous or non-continuous. Moreover, the seals 20, 22 may be positioned in a variety of positions relative to the first component 12, the second component 14 and the member 16. In the particular embodiment shown, the first seal 20 is positioned between the first surface 56 of the flange 74 at the first end 70 of the member 16 and the second surface 30 of the first component 12. The second seal 22 is shown as positioned between the second surface 58 of the flange 76 at the second end 72 of the member 16 and the second surface 46 of the second component 14. Each of the seals 20, 22 is preferably a continuous annular ring that continuously seals between the member 16 and the components 12, 14.

The seals 20, 22 may be formed of several different materials. Generally speaking, the assembly 10 may utilize technology and processes for the seals 20, 22 such as those disclosed in U.S. Pat. Nos. 4,922,596, 4,978,562, 5,124,186, and 5,884,960 and commonly owned, co-pending U.S. application Ser. No. 09/502,686 filed Feb. 11, 2000 and Ser. No. 09/524,961 filed Mar. 14, 2000, all of which are expressly incorporated by reference. Preferably, the seals 20, 22 are formed of an expandable material that is formed of a high compressive strength heat activated reinforcement material having foamable characteristics. The material may be generally dry to the touch or tacky and can be placed upon the member 16, the components 12, 14 or the like in any form of desired pattern, placement, or thickness, but is preferably a substantially uniform thickness. One exemplary expandable material is L-5204 structural foam available through L&L Products, Inc. of Romeo, Mich.

Though other heat activated materials are possible for the seals 20, 22 a preferred heat activated material is an expandable polymer or plastic, and preferably one that is foamable. A particularly preferred material is an epoxy-based structural foam. For example, without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based structural reinforcing or sealing foams are known in the art and may also be used to produce the structural foam. A typical structural foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow.

An example of a preferred structural foam formulation is an epoxy-based material that is commercially available from L&L Products of Romeo, Mich., under the designations L5206, L5207, L5208, L5209, L-2105, L-2100, L-7005 or L-2018, L-7101, L-7102, L-2411, L-2412, L-4141, XP321 and XP721. One advantage of the preferred structural foam materials over prior art materials is that the preferred materials can be processed in several ways. The preferred materials can be processed by injection molding, extrusion compression molding or with a mini-applicator. This enables the formation and creation of part designs that exceed the capability of most prior art materials. In one preferred embodiment, the structural foam (in its uncured state) generally is dry or relatively free of tack to the touch and can easily be attached to the members 16 or components 12, 14 through fastening means which are well known in the art.

While the preferred materials for fabricating the expandable material for the seals 20, 22 have been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the material for the seals 20, 22 include relatively high stiffness, high strength, high glass transition temperature (typically greater than 70 degrees Celsius), and good corrosion resistance properties. In this manner, the material does not generally interfere with the materials systems employed by automobile manufacturers. Exemplary materials include materials sold under product designation L4100 and L4200, which are commercially available from L & L Products, Romeo, Mich.

In applications where the expandable material for the seals 20, 22 is a heat activated, thermally expanding material, an important consideration involved with the selection and formulation of the material comprising the structural foam is the temperature at which a material reaction or expansion, and possibly curing, will take place. For instance, in most applications, it is undesirable for the material to be reactive at room temperature or otherwise at the ambient temperature in a production line environment. More typically, the structural foam becomes reactive at higher processing temperatures, such as those encountered in an automobile assembly plant, when the foam is processed along with the automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges.

Generally, suitable expandable foams have a range of expansion ranging from approximately 0 to over 1000 percent. The level of expansion of the seals 20, 22 may be increased to as high as 1500 percent or more. Typically, strength is obtained from products that possess low expansion. Preferred levels of expansion are between about greater than 0% and about 500%, more preferably between about 50% and about 350% and even more preferably between about 200% and about 300%.

Some other possible materials for the seals 20, 22 include, but are not limited to, polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference). In general, the desired characteristics of the resulting material include relatively low glass transition point, and good corrosion resistance properties. In this manner, the material does not generally interfere with the materials systems employed by automobile manufacturers. Moreover, it will withstand the processing conditions typically encountered in the manufacture of a vehicle, such as the e-coat priming, cleaning and degreasing and other coating processes, as well as the painting operations encountered in final vehicle assembly.

In another embodiment, the expandable material of the seals 20, 22 is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen pillar structure or door beam, and applying it thereto.

The skilled artisan will appreciate that the system may be employed in combination with or as a component of a conventional sound blocking baffle, or a vehicle structural reinforcement system, such as is disclosed in commonly owned co-pending U.S. application Ser. No. 09/524,961 or 09/502,686 (hereby incorporated by reference).

It is contemplated that the material of the seals 20, 22 could be delivered and placed into contact with the assembly members and/or components, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

In particularly preferred embodiments, as suggested, the material for the seals 20, 22 is formulated to be fuel resistant. In one such embodiment, the material is substantially formulated of an ethylene-based material and includes an ethylene with one or more copolymers. Preferably, the ethylene-based material includes up to or at least 60 percent by weight or greater ethylene, more preferably at least 70 percent by weight ethylene and even more preferably at least 80 percent by weight ethylene. Exemplary copolymers or comonomers of the material include, but are not limited to methyl acrylate, vinyl acetate or the like. The copolymer or comonomer of the ethylene-base material may represent up to, or greater than about 40% by weight of the material, but is more preferably no greater than 30% by weight of the material, even more preferably no greater than 20% by weight of the material and still more preferably no greater than 10% by weight of the material. Advantageously, such materials tend to have relatively greater crystallinity, which without being bound by any theory, assists in forming materials that are more fuel resistant.

In other embodiments, the material for the seals 20, 22 is formulated with other polymers or elastomers that tend to exhibit fuel resistance. In one preferred embodiment, such materials are epoxy-based polymers. In other preferred embodiments, such materials are elastomeric materials such as nitrile butadienes.

Assembly

The components, members and seals of the fuel fill assembly may be assembled together according to many different techniques or protocols and may be assembled in a variety of different orders. For example, and without limitation, the member 16 may be attached to the components 12, 14 prior to applying the seals 20, 22 to the assembly 10. Alternatively, one or both of the seals 20, 22 may be attached to the components 12, 14 or member 16 prior to assembling the components 12, 14 and member 16 together or the seals 20, 22 may be used to attach the components 12, 14 to the member 16.

According to one embodiment, the material for the seals 20, 22 is applied to (e.g., molded or extruded in place upon) the member 16, the components 12, 14 or a combination thereof. Preferably, the material of the seals 20, 22 is heated to a viscoelastic state without substantially activating the material, but still allowing the material to adhere to one or more of the surfaces 28, 30, 44, 46, 56, 58 of the member 16, the components 12, 14 or a combination thereof.

Prior to, during or after applying the material of the seals 20, 22 to the components 12, 14 and/or the member 16, the components 12, 14 and the member 16 are positioned with respect to each other. In the preferred embodiment illustrated, fasteners 90 (e.g., mating snap fits fasteners) are provided upon the member 16, the components 12, 14 or a combination thereof such that the member 16 may be maintained in its position between the components 12, 14 until the member 16 is more fully attached to the components 12, 14.

In a highly preferred embodiment, the member 16 is mechanically fastened to the first component 12 with the first seal 20 located at least partially therebetween. Thereafter, the first component 12 is assembled to an automotive vehicle or other transportation vehicle such that the second seal 22 is located at least partially between the member 16 and the second component 14. In this configuration, the opening 34 of the first component 12 and the opening 48 of the second component 14 should at least partially align with the open space 60.

For completing the attachment of the member 16 to the components 12, 14, the material of the seals 20, 22 is activated (e.g., by exposure to heat) such that the material expands to wet the surfaces 30, 46, 56, 58 of the components 12, 14 and member 16. Thereafter, the material of the seals 20, 22 cures and adheres to the surfaces 30, 46, 56, 58 thereby attaching the member 16 to the components 12, 14 with a strong bond while also preferably providing the seals 20, 22 as substantially continuous about the open space 60 and as substantially fluid tight between the surfaces 30, 46, 56, 58.

In a preferred embodiment, only the seals 20, 22 provide substantially all of the strength of attachment between the member 16 and the components 12, 14 without additional fastening (e.g., by welding, additional fasteners or the like). In such an embodiment, the fasteners 90 for maintaining the member 16 in position typically provide relatively little strength for attaching the member 16 to the component 12, 14 as compared to the seals 20, 22. Of course, it is contemplated that, if desired, the fasteners 90 or other additional fasteners may be used to help secure the member 16 and the components 12, 14 together.

In addition to the member 16 and the components 12, 14, the fuel fill assembly 10 of the present invention may also include additional components as well. For example, the assembly may include a hinged door for providing access to the open space 60 defined by the assembly 10. It is contemplated that such a door may be attached to the member 16, the components 12, 14 or a combination thereof. Other components may include members for guiding a nozzle or other dispenser relative to the assembly.

Operation

In operation, a nozzle or other dispensing unit may be placed adjacent or inserted at least partially within the open space 60 followed by dispensing gas or other fuel through the open space 60. Advantageously, due to the fuel resistant nature of the material of the seals 20, 22, the seals 20, 22 can provide a strong attachment between the member 16 and the components 12, 14 as well as providing sealing about the open space 60.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method of forming a fuel fill assembly for a transportation vehicle, the method comprising:
(a) providing a first component of the transportation vehicle, the first component defining an opening;
(b) providing a second component of the transportation vehicle, the component defining an opening;
(c) providing a plastic annular member extending between a first end and a second end, the plastic annular member having an inner surface defining an open space;
(d) applying an expandable polymeric material upon at least one of the first member and the plastic annular member for forming a first seal;
(e) applying an expandable polymeric material upon at least one of the second member and the plastic annular member for forming a second seal; and
(f) expanding the first seal and the second seal such that:
i) the first seal is adhered to a surface of the first component and a surface of the plastic annular member; and
ii) the second seal is adhered to a surface of the second component and a surface of the plastic annular member.

2. A method as in claim 1 wherein the second component is selected from a body side inner panel and a wheelhouse.

3. A method as in claim 1 further comprising:
maintaining the position of the plastic annular member relative to the first component with one or more mechanical fasteners and assembling the first component to the vehicle prior to the step of expanding the first seal and the second seal, wherein the step of assembling the first component to the vehicle interconnects the opening of the second component with the open space.

4. A method as in claim 1 wherein the first seal is a substantially continuous annular ring.

5. A method as in claim 1 wherein the second seal is a substantially continuous annular ring.

6. A method as in claim 3 wherein the one or more mechanical fasteners are mating fasteners or snap-fit fasteners.

7. A method as in claim 1 wherein the first seal and the second seal include at least about 60% by weight ethylene.

8. A method as in claim 1 wherein the first seal and the second seal include an effective amount of copolymer or comonomer of ethylene for providing crystallinity to the first seal and second seal, the effective amount being up to about 40% by weight of the material of the first seal and the material of the second seal.

9. A method as in claim 1 wherein the two steps of applying the expandable material include heating the expandable material to a viscoelastic state without activating the expandable material.

10. A method as in claim 1 wherein the first seal expands between about 50% and about 350%.

11. A method as in claim 1 wherein the expandable material for seals is fuel resistant.

12. A method as in claim 1 wherein the annular member includes a first flange at the first end and a second flange at the second end, the first seal positioned between the first flange and the first component, the second seal positioned between the second flange and the second component.

13. A method as in claim 1 wherein the annular member is attached to the first component and the second component without any welds.

14. A method of forming a fuel fill assembly for an automotive vehicle, the method comprising:
(a) providing a body side outer panel of the automotive vehicle, the outer panel defining an opening;
(b) providing a wheelhouse of the automotive vehicle, the wheelhouse defining an opening;
(c) providing a plastic annular member extending between a first end and a second end, the plastic annular member having an inner surface defining an open space;
(d) extruding an expandable polymeric material upon at least one of the outer panel and the plastic annular member for forming a first seal;
(e) extruding an expandable polymeric material upon at least one of the wheelhouse and the plastic annular member or forming a second seal;
(f) maintaining the position of the plastic annular member relative to the outer panel with mechanical fasteners; and
(g) expanding the first seal and the second seal such that:
i) the first seal is adhered to a surface of the outer panel and a surface of the plastic annular member;
ii) the second seal is adhered to a surface of the wheelhouse and a surface of the plastic annular member; and
iii) the open space is interconnected with the opening of the outer panel and the opening of the wheelhouse.

15. A method as in claim 14 wherein the one or more mechanical fasteners are mating fasteners or snap-fit fasteners.

16. A method as in claim 14 wherein the first seal and the second seal include at least about 60% by weight ethylene.

17. A method as in claim 1 wherein the first seal and the second seal include an effective amount of copolymer or comonomer of ethylene for providing crystallinity to the first seal and second seal, the effective amount being up to about 40% by weight of the material of the first seal and the material of the second seal.

18. A method as in claim 1 wherein the two steps of applying the expandable material include heating the expandable material to a viscoelastic state without activating the expandable material.

19. A method as in claim 1 wherein the first seal expands between about 50% and about 350%.

20. A method as in claim 1 wherein the expandable material for first seal and the second seal is fuel resistant.

21. A method as in claim 1 wherein the annular member includes a first flange at the first end and a second flange at the second end, the first seal positioned between the first flange and the outer panel, the second seal positioned between the second flange and the wheelhouse.

22. A method as in claim 1 wherein the annular member is attached to the outer panel and the wheelhouse without any welds.
